(19) United States
(12) Patent Application Publication
(10) Pub. No.: US 2024/0217085 A1
(43) Pub. Date: Jul. 4, 2024

(54) Cleaning Tool Handle Device

(71) Applicant: Chris Scoular, Rockhaven (CA)

(72) Inventor: Chris Scoular, Rockhaven (CA)

(21) Appl. No.: 18/397,518

(22) Filed: Dec. 27, 2023

Related U.S. Application Data
(60) Provisional application No. 63/436,752, filed on Jan. 3, 2023.

(51) Int. Cl. B25G 1/10; B25G 1/04

(52) U.S. Cl. CPC B25G 1/102; B25G 1/04

(57) ABSTRACT

A cleaning tool handle device is provided. The device is primarily comprised of a body, a first end, and a second end. The first end of the body may receive any cleaning device known in the art. By gripping the handle of the body, the device may be used to clean surfaces typically out of reach from a user. The user may further rest a forearm on the second end of the device thus decreasing the movement experienced at the handle and providing a more stable device from which surfaces may be cleaned.

### CROSS-REFERENCE TO RELATED APPLICATION

The present application claims priority to, and the benefit of, U.S. Provisional Application No. 63/436,752, which was filed on Jan. 3, 2023, and is incorporated herein by reference in its entirety.

### FIELD OF THE INVENTION

The present invention relates generally to the field of cleaning devices. More specifically, the present invention relates to a cleaning tool handle device comprised of a tubular body from which a cleaning device may be received by the first end of the body. By gripping the handle and resting forearm support on the second end of the body, the device may be stabilized when used to clean surfaces that are typically out of reach from the user. Accordingly, the present disclosure makes specific reference thereto. Nonetheless, it is to be appreciated that aspects of the present invention are also equally applicable to other like applications, devices, and methods of manufacture.

### BACKGROUND

Many conventional cleaning tools, such as brushes and sponges, rely on the manual application of pressure from a hand or other body part to effectively clean a surface. This approach can be effective for surfaces that are easily accessible and within comfortable reach. However, there are many situations in which surfaces may be difficult to reach, either because a user must extend their arm over an obstacle to access the surface, or because the surface itself extends vertically, such as a tall window or a wall. Cleaning these out-of-reach surfaces presents a number of challenges.

First, the user may quickly become fatigued when moving the cleaning device back and forth in such an extended position, as the user's arm muscles must work harder to maintain the necessary pressure on the cleaning tool, leading to discomfort and reduced efficiency in the cleaning process. Moreover, the effectiveness of the cleaning may be diminished due to the reduced force that can be applied in such awkward positions.

Second, the user may be tempted to use the surface being cleaned as a secondary point of contact to lean against, in order to stabilize themselves or reach further. However, this can result in dirtying their clothes with the accumulated dirt or cleaning solution on the surface, defeating the purpose of the cleaning process. Additionally, leaning against the surface that is to be cleaned can transfer dirt or contaminants from the user's clothing back onto the surface, negating the efforts to clean it in the first place.

Therefore, there exists a long-felt need in the art for a device that can clean out of reach surfaces. More specifically, there exists a long-felt need in the art for a cleaning tool handle device that can easily change its length to accommodate cleaning surfaces at varying degrees of distance away from the user. Furthermore, there exists a long-felt need in the art for a cleaning tool handle device that can receive any type of cleaning object known in the art such that the device can be used to clean any surface effectively.

The subject matter disclosed and claimed herein, in one embodiment thereof, comprises a cleaning tool handle device. The device is primarily comprised of a body, a first end, and a second end. The first end of the body may receive any cleaning device known in the art. By gripping the handle of the body, the device may be used to clean surfaces typically out of reach from A user. The user may further rest a forearm on the second end of the device thus decreasing the moment experienced at the handle and providing a more stable device from which surfaces may be cleaned.

In this manner, the cleaning tool handle device of the present invention accomplishes all the foregoing objectives and provides a device that can clean out of reach surfaces easily. More specifically, the cleaning tool handle device can provide additional stability when trying to clean surfaces typically out of reach from the user. Furthermore, the cleaning tool handle device can receive any cleaning object such as a brush, sponge, rake, etc., to clean differing surfaces effectively.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cleaning tool handle device primarily comprised of a body, a first end, and a second end. The device is designed to receive a single blade cleaning device or any other cleaning object and extend such that the device can be used to clean typically out of reach surfaces.

The device is comprised of a tubular body that is preferably made from a plastic material. In one potential embodiment, the body may be comprised of multiple telescoping tubes that allow the body to change in length. A locking member may be secured to the telescoping tubes to temporarily fix the length of the body once the body is at a length desired by a user.

The body is further comprised of a first end, a handle, and a second end. The first end is comprised of an opening in which a handle of a cleaning device may be inserted. In one potential embodiment, a fastener may be used to secure the cleaning device to the first end or to be used in conjunction with the opening to better secure the cleaning device to the first end. A user may grip the device at the handle with a hand. The forearm of the same arm used to grip the handle may rest on a forearm support of the second end of the body. By resting the forearm on the second end, the device may be stabilized when cleaning out of reach surfaces. The forearm support may be further comprised of a padding and at least one fastener to provide comfort and additional stability to the forearm of the user.

The present invention is also comprised of a method of using the device. First, a device is provided comprised of a body, a first end, and a second end. Then, the single blade cleaning device may be inserted into the opening of the first end of the body. Then, a user may grab the handle and rest their forearm on the forearm support of the second end. Next, the user may clean a surface, such as a windshield, by moving the single blade cleaning device along the surface.

The present invention is also comprised of a second method of using the device. First, a device is provided comprised of a body, a first end, and a second end. Then, the single blade cleaning device may be secured to the first end of the body via at least one fastener. Then, a user may grab the handle and rest their forearm on the forearm support of the second end. Next, the user may clean a surface, such as a windshield, by moving the single blade cleaning device along the surface.

The present invention is also comprised of a third method of using the device. First, a device is provided comprised of a body, a first end, and a second end. Then, the single blade cleaning device may be inserted into the first end of the body and secured via at least one fastener. Then, a user may grab the handle and rest their forearm on the forearm support of the second end. Next, the forearm of the user may be secured to the forearm support via at least one fastener. Then, the user may clean a surface, such as a windshield, by moving the single blade cleaning device along the surface.

Accordingly, the cleaning tool handle device of the present invention is particularly advantageous as it provides a device that can clean out of reach surfaces easily. More specifically, the cleaning tool handle device can receive any cleaning object to clean differing surfaces effectively. Furthermore, the cleaning tool handle device can easily provide additional stability when trying to clean out of reach surfaces. In this manner, the cleaning tool handle device overcomes the limitations of existing cleaning devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cleaning tool handle device of the present invention with a cleaning device received by the device in accordance with the disclosed architecture;

FIG. 2 illustrates a perspective view of one potential embodiment of a cleaning tool handle device of the present invention with a cleaning device received by the device while the device is being used to clean a windshield in accordance with the disclosed architecture;

FIG. 3 illustrates a flowchart of a method of using one potential embodiment of a cleaning tool handle device of the present invention in accordance with the disclosed architecture;

FIG. 4 illustrates a flowchart of a method of using one potential embodiment of a cleaning tool handle device of the present invention in accordance with the disclosed architecture; and

FIG. 5 illustrates a flowchart of a method of using one potential embodiment of a cleaning tool handle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can clean out of reach surfaces. More specifically, there exists a long-felt need in the art for a cleaning tool handle device that can easily change its length to accommodate cleaning surfaces at varying degrees of distance away from the user. Furthermore, there exists a long-felt need in the art for a cleaning tool handle device that can receive any type of cleaning object known in the art such that the device can be used to clean any surface effectively.

The present invention, in one exemplary embodiment, is comprised of a cleaning tool handle device. The device is primarily comprised of a body, a first end, and a second end. The device is designed to receive a single blade cleaning device or any other cleaning object and extend such that the device can be used to clean typically out of reach surfaces.

More specifically, the device is comprised of a generally tubular body. The body is preferably made from a plastic material. In one potential embodiment, the body is comprised of two telescoping tubes that allow the body to change in length. In this embodiment, the body is further comprised of a locking member that may temporarily fix the length of the body to a length desired by the user. The locking member may lock the length of the body in place by twisting, fastening, or any other method.

The body is further comprised of a first end, a handle, and a second end. The first end is further comprised of an opening in which a handle of a single blade cleaning device or other cleaning device may be inserted. The opening may receive the single blade cleaning device and secure the single blade cleaning device to the first end of the body via at least one fastener. The handle provides a point of contact for a hand of a user to hold onto the device. The handle may be further comprised of a grip area that is made from a differing material or comprised of a plurality of protrusions to enhance the grip of the device. The second end is further comprised of a forearm support in which a forearm of the user may rest. The forearm support may be further comprised of padding and at least one fastener in differing embodiments. The padding may provide comfort to the forearm of the user resting on the forearm support whereas the fastener may secure the forearm to the forearm support, providing additional stability to the device.

The present invention is also comprised of a method of using the device. First, a device is provided comprised of a body, a first end, and a second end. Then, the single blade cleaning device may be inserted into the opening of the first end of the body. Then, a user may grab the handle and rest their forearm on the forearm support of the second end. Next, the user may clean a surface, such as a windshield, by moving the single blade cleaning device along the surface.

The present invention is also comprised of a second method of using the device. First, a device is provided comprised of a body, a first end, and a second end. Then, the single blade cleaning device may be secured to the first end of the body via at least one fastener. Then, a user may grab the handle and rest their forearm on the forearm support of the second end. Next, the user may clean a surface, such as a windshield, by moving the single blade cleaning device along the surface.

The present invention is also comprised of a third method of using the device. First, a device is provided comprised of a body, a first end, and a second end. Then, the single blade cleaning device may be inserted into the first end of the body and secured via at least one fastener. Then, a user may grab the handle and rest their forearm on the forearm support of the second end. Next, the forearm of the user may be secured to the forearm support via at least one fastener. Then, the user may clean a surface, such as a windshield, by moving the single blade cleaning device along the surface.

Accordingly, the cleaning tool handle device of the present invention is particularly advantageous as it provides a device that can clean out of reach surfaces easily. More specifically, the cleaning tool handle device may provide additional stability when attempting to clean surfaces typically out of reach from a user. Furthermore, the cleaning tool handle device can allow any cleaning device to be attached such that the device can clean any surface effectively. In this manner, the cleaning tool handle device overcomes the limitations of existing cleaning devices known in the art.

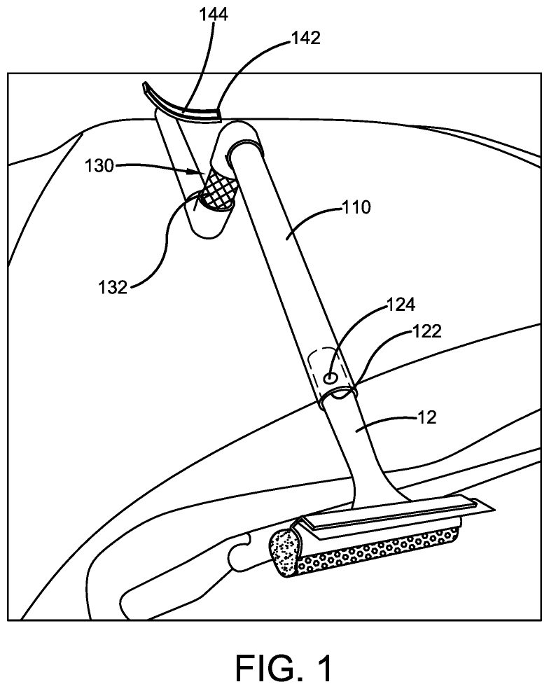

Referring initially to the drawings, FIG. 1 illustrates a perspective view of one potential embodiment of a cleaning tool handle device 100 of the present invention with a cleaning device 10 received by the device 100 in accordance with the disclosed architecture. The device 100 is primarily comprised of a body 110 having a first end 120, and a second end 140. The device 100 is designed to receive a single blade cleaning device 10 (or any other cleaning device of the like) and serve as an extension of the device such that the device 100 can be used to clean typically out of reach surfaces, such as a windshield 20.

The device 100 is comprised of a generally cylindrical body 110 that may be hollow, thus decreasing the weight of the device 100. The body 110 may be made from any material but is preferably made from a plastic material, such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, etc. In one potential embodiment, the body 110 is telescopic such that the body 110 of the device 100 may extend/retract in length as needed. In this embodiment, the body 110 may be comprised of at least one locking member 112 that allows a user to temporarily fix the length of the body 110. The locking member 112 may be any member known in the art typically used for securing telescoping poles such as, but not limited to, a clamp, a twist lock, a button clip, a ball lock pin, etc.

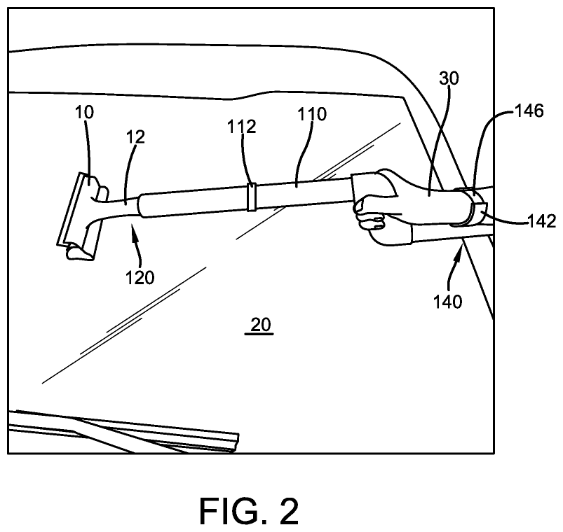

FIG. 2 illustrates a perspective view of one potential embodiment of a cleaning tool handle device 100 of the present invention with a cleaning device 10 received by the device 100 while the device 100 is being used to clean a windshield 20 in accordance with the disclosed architecture. The body 110 is further comprised of a first end 120 having at least one handle 130, and a second end 140. The first end 120 is further comprised of at least one opening 122 which may receive any portion of any cleaning device 10. In one potential embodiment, the first end 120 may be comprised of at least one fastener 124. The fastener 124 allows a handle 12 of a cleaning device 10 to removably attach to the exterior of the first end 120. In another potential embodiment, the opening 122 and the fastener 124 of the first end 120 may both be used to allow a cleaning device 10 to attach to the first end 120 such that the handle 12 of the cleaning device 10 may be inserted into the opening 122 and secured via the fastener 124. The fastener 124 may include, but is not limited to, an opening, a clip, a clamp, a magnet, a tongue, a groove, etc.

The handle 130 of the body 110 may be gripped by a hand of a user during use. The handle 130, in one potential embodiment, may be comprised of at least one grip area 132 to enhance the grip or comfort of the user. The grip area 132 may be made from a differing material, such as rubber, or be comprised of raised or recessed grooves, protrusions, indentations, or any other contours to enhance the grip or comfort of the user.

The second end 140 may be further comprised of at least one forearm support 142 that is preferably curved to receive a forearm/arm of a user. The forearm support 142 may be fixedly or removably attached to the second end 140 of the body 110. The forearm support 142 allows a user to rest a forearm 30 of the same arm in which the handle 130 is gripped by a hand of the user. By resting a forearm 30 on the second end 140 of the body 110, the movement about the handle 130 may decrease, allowing a user to more easily clean a surface, such as a windshield 20. In differing embodiments, support 142 (and/or other portion of the second end 140) may be further comprised of a padding 144 and an at least one fastener 146. The padding 144 may provide additional comfort to the forearm 30 of the user. The fastener 146 may secure the forearm 30 to the forearm support 142, providing additional stability when using the device 100. The fastener 146 may be any fastener such as, but not limited to, elastic, a hook and loop strap, a snap button strap, etc.

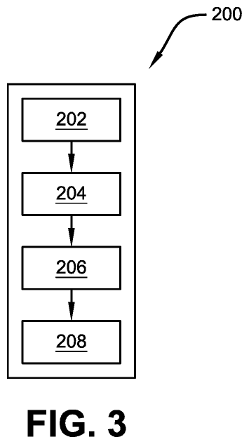

The present invention is also comprised of a method 200 of using the device 100, as seen in FIG. 3. First, a device 100 is provided comprised of a body 110 having a first end 120 and a second end 140 [Step 202]. Then, a handle 12 of a single blade cleaning device 10 may be inserted into the opening 122 of the first end 120 of the body 110 [Step 204]. Next, a user may grab the handle 130 and rest their forearm 30 on the forearm support 142 of the second end 144 [Step 206]. Then, the user may clean a surface, such as, but not limited to, a windshield 20, by moving the single blade cleaning device 10 along the surface [Step 208].

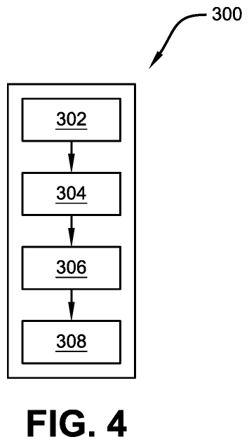

The present invention is also comprised of a second method 300 of using the device 100, as seen in FIG. 4. First, a device 100 is provided comprised of a body 110 having a first end 120 and a second end 140 [Step 302]. Then, a single blade cleaning device 10 may be secured to the exterior of first end 120 of the body 110 via at least one fastener 124 [Step 304]. Then, a user may grab the handle 130 and rest their forearm 30 on the forearm support 142 of the second end 140 [Step 306]. Next, the user may clean a surface, such as a windshield 20, by moving the single blade cleaning device 10 along the surface [Step 308].

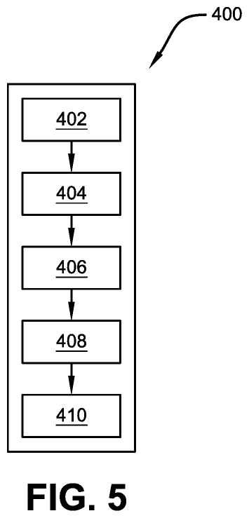

The present invention is also comprised of a third method 400 of using the device 100, as seen in FIG. 5. First, a device 100 is provided comprised of a body 110 having a first end 120 comprised of an opening 122, and a second end 140 [Step 402]. Then, the handle 12 of the single blade cleaning device 10 may be inserted into the opening 122 of the first end 120 of the body 110 and secured within the opening 122 and at least one fastener 124 [Step 404]. Then, a user may grab the handle 130 and rest their forearm 30 on the forearm support 142 of the second end 140 [Step 406]. Next, the forearm 30 of the user may be secured to the forearm support 142 via at least one fastener 146 [Step 408]. Then, the user may clean a surface, such as a windshield 20, by moving the single blade cleaning device 10 along the surface [Step 410].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “cleaning tool handle device” and “device” are interchangeable and refer to the cleaning tool handle device 100 of the present invention.

Notwithstanding the foregoing, the cleaning tool handle device 100 of the present invention and its various components can be of any suitable size and configuration as is known in the art without affecting the overall concept of the invention, provided that they accomplish the above-stated objectives. One of ordinary skill in the art will appreciate the size, configuration, and material of the cleaning tool handle device 100 as shown in the FIGS. are for illustrative purposes only, and that many other sizes and shapes of the cleaning tool handle device 100 are well within the scope of the present disclosure. Although the dimensions of the cleaning tool handle device 100 are important design parameters for user convenience, the cleaning tool handle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning tool handle device comprising:
a body comprised of a first end, a second end, and a handle; and
a forearm support positioned on the second end.

2. The cleaning tool handle device of claim 1, wherein the body is comprised of a telescopic body.

3. The cleaning tool handle device of claim 2, wherein the body is comprised of a locking member that secures the body at a length.

4. The cleaning tool handle device of claim 3, wherein the locking member is comprised of a clamp, a twist lock, a button clip, or a ball lock pin.

5. The cleaning tool handle device of claim 1, wherein the handle is comprised of a fastener.

6. The cleaning tool handle device of claim 1, wherein the first end is comprised of an opening.

7. The cleaning tool handle device of claim 1, wherein the handle is comprised of a grip area.

8. The cleaning tool handle device of claim 7, wherein the grip area is comprised of a texture.

9. A cleaning tool handle device comprising:
a body comprised of a first end comprised of an opening, a second end, and a handle; and
a forearm support positioned on the second end.

10. The cleaning tool handle device of claim 9, wherein the opening is comprised of a fastener.

11. The cleaning tool handle device of claim 10, wherein the fastener is comprised of an opening, a clip, a clamp, a magnet, a tongue, or a groove.

12. The cleaning tool handle device of claim 9, wherein the forearm support is comprised of a padding.

13. The cleaning tool handle device of claim 9, wherein the forearm support is curved.

14. The cleaning tool handle device of claim 9, wherein the forearm support is comprised of a forearm support fastener.

15. The cleaning tool handle device of claim 14, wherein the forearm support fastener is comprised of an elastic fastener, a hook and loop strap, or a snap button strap.

16. The cleaning tool handle device of claim 9, wherein the handle is comprised of a grip area.

17. The cleaning tool handle device of claim 16, wherein the grip area is comprised of a texture.

18. A method of using a cleaning tool handle device, the method comprising the following steps:
providing a cleaning tool handle device comprised of a body comprised of a first end and a second end;
attaching a cleaning device to the first end;
grabbing a handle of the cleaning tool handle device and resting a forearm on a forearm support of the cleaning tool handle device; and
cleaning a surface using the cleaning device.

19. The method of using a cleaning tool handle device of claim 18 further comprised of a step of attaching the cleaning device to the first end via a fastener.

20. The method of using a cleaning tool handle device of claim 18 further comprised of a step of attaching the cleaning device to an opening of a first end via a fastener.
